(19) United States
(12) Patent Application Publication
(10) Pub. No.: US 2006/0109523 A1
(43) Pub. Date: May 25, 2006

(54) Method for generating multiple output formats for a scanned document

(75) Inventor: Ian C. Hamilton, Letchworth Garden City (GB)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/995,667

(22) Filed: Nov. 23, 2004

(51) Int. Cl. H04N 1/32; H04N 1/40

(52) U.S. Cl. 358/468

(57) ABSTRACT

A method for copying a document, which includes scanning the document exactly one time, selecting a first set of document characteristics for the document, selecting a second set of document characteristics for the document, and after the first and second set of document characteristics are received, automatically receiving at least one first copy having the first set of document characteristics and at least one second copy having the second set of document characteristics.

The embodiments disclosed herein are directed to image output devices and more specifically, to methods for outputting a scanned document in multiple different formats.

There are multiple reasons that one may have for scanning a document. For example, one may want a copy to mark-up a file or archive copy, or a formal copy to submit to another person or entity. Further, the person scanning these documents may want hard copies or electronic copies or both.

To print a document in multiple formats or types of output typically requires the user to resubmit the document to the output device multiple times, once for each type of output. When a document is submitted through a scanner, it can be time consuming to keep rescanning the document for each desired output, especially if the document is particularly large. It would be useful to be able to designate multiple destinations and formats for a document at the time of scanning so that the document need only be scanned once.

Embodiments include a method for copying a document. This method includes selecting at least two different sets of document characteristics for a document. The document is scanned and at least two different copies of the document are produced, wherein one copy is formatted according to the first set of document characteristics and the other copy is formatted according to the second set of document characteristics.

Embodiments include a method for copying a document, which includes scanning the document exactly one time, selecting a first set of document characteristics for the document, selecting a second set of document characteristics for the document, and after the first and second set of document characteristics are received, automatically receiving at least one first copy having the first set of document characteristics and at least one second copy having the second set of document characteristics.

Various exemplary embodiments will be described in detail, with reference to the following figures, wherein:

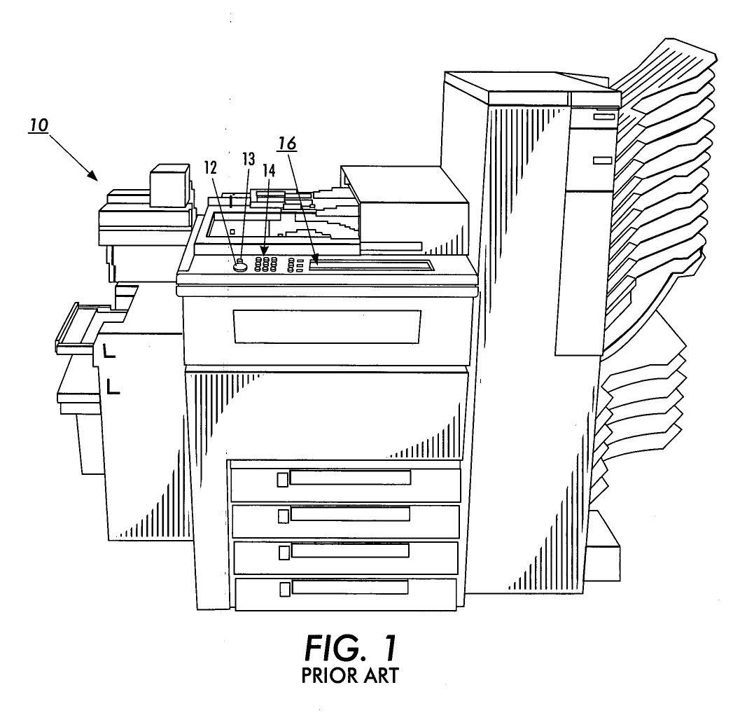

FIG. 1 is an illustration of an exemplary embodiment of a multi-function device.

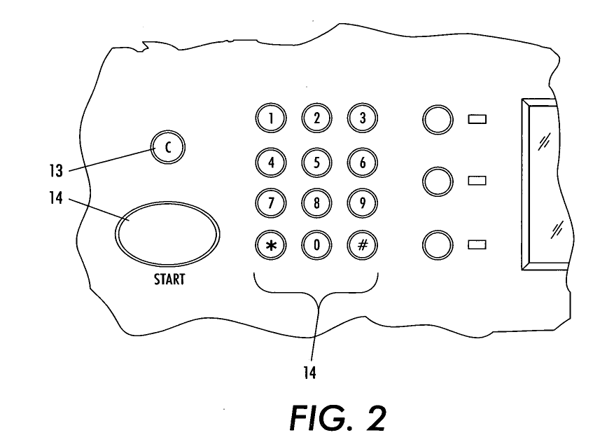

FIG. 2 is a close-up illustration of an exemplary embodiment of controls for the multi-function device of FIG. 1.

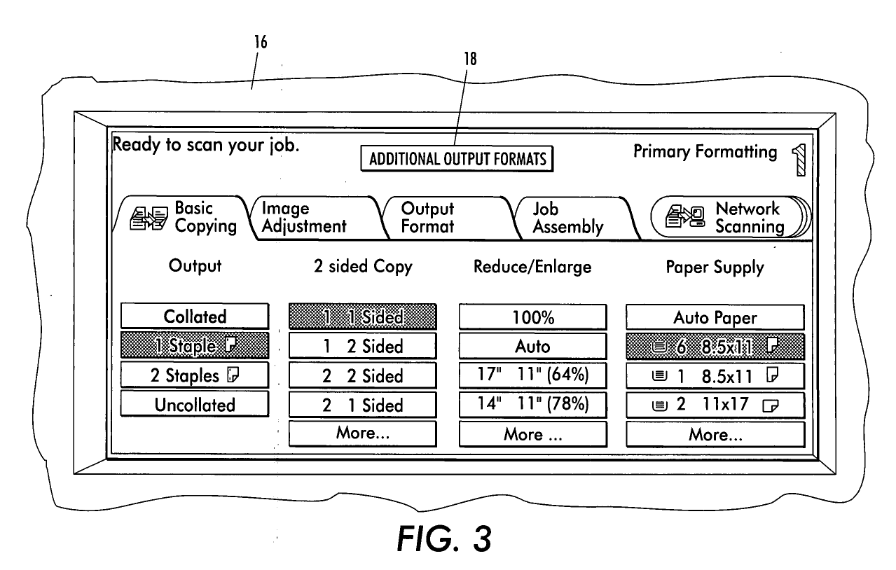

FIG. 3 is an illustration of an exemplary embodiment of a first selection screen of a user interface of the multi-function device of FIG. 1.

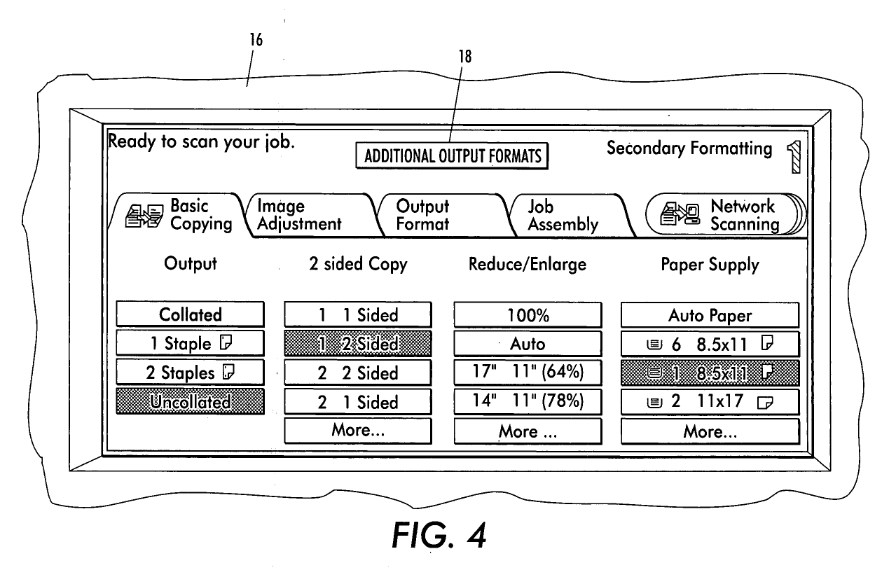

FIG. 4 is an illustration of an exemplary embodiment of a second selection screen of the user interface of the multi-function device of FIG. 1.

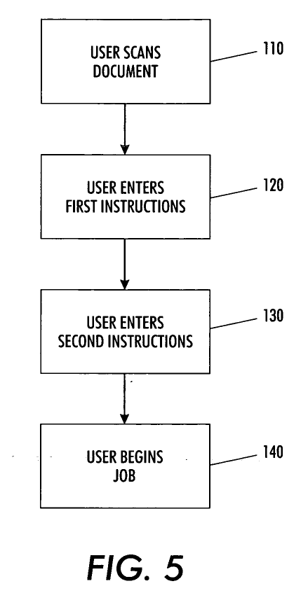

FIG. 5 is a flowchart describing the method of the present invention.

Briefly, the embodiments disclosed herein are directed to a method for outputting a document in multiple formats after a single input, typically by scanning.

A document may include any information that can be fixed to a two-dimensional surface. A document may include, for example, text, images, and glyphs.

FIG. 1 illustrates an exemplary embodiment of an image output device 10. An image output device is any device capable of producing an image either electronically or in hard copy. In the present case image output device 10 is a multifunction device capable of being networked to an intranet, internet, or facsimile device and of producing a corresponding variety of electronic and hard copy images. A multi-function device is a subset of image output devices. The device 10 may alternatively hereafter be referred to as an image output device or a multi-function device.

The device 10 includes various input mechanisms such as the start 12, cancel 13, numerical keypad 14 buttons and a user interface 16. The buttons 12, 13, 14 can be seen more clearly in FIG. 2 and the user interface 16 can be seen more clearly in FIGS. 3 and 4.

The user interface 16 can include a variety of output options for the user. These can range from basic (for example, hard copy, scan to file, scan to email, and scan to recordable medium) to more detailed (paper size, paper thickness, color or black-and-white, magnification, etc.) The user usually scans his document in at the device.

Sometimes, a user scanning a document may want multiple output formats. For example, the user may want a first format for a formal report and a second format for archival purposes. The formal report may require one page per single-sided legal sheet of paper in color. Influenced by monetary concerns, 2-up duplex black-and-white may suffice for the archival copy. In other cases, the user may want to print a copy or copies and also scan the document to email at the same time.

Currently, to receive multiple different outputs from a scanned document, the user must scan the document once for a first output, again for a second, etc. Alternatively, the user can scan the document to an electronic form, which is then kept on an electronic storage or memory device (separate from the multifunction device 10) or sent to an email account. The user would then use a device such as a computer that is either directly connected or remotely connected through an electronic net to the multifunction device to print/fax/email copies of the electronic file from as needed. It would save time and effort for the user if the user could specify all the various output formats desired at the time of scan so that repeated scanning or use of another device in addition to the multi-function device is not required.

In embodiments, the user interface 16 may include a secondary screen upon which the user may select a second set of options. For example, a user may approach a multifunction device such as device 10. A user would enter a first set of output criteria through the user interface 16. The user would then enter a second set of output criteria through the user interface 16, as shown in FIG. 4. For the first set of criteria, the user has selected one staple, one-sided output copy of a one-sided original, and 8.5×11 paper from tray 6. In FIG. 4 the user has selected uncollated, one-sided to two-sided conversion, and 8.5×11 paper from tray 1.

As shown, the choices available for the second set of output criteria are identical to those for the first, but this does not have to be the case. In embodiments, the second user interface may have more, less, or different choices than the first.

In the figures, we have only shown two sets of selection choices. There is no reason why third, fourth and more output characteristics could not be entered as well.

There are many ways in which the device could decide to prompt the user for a second set of criteria. For example, the user interface may incorporate a special button or a prompt that appears automatically when two or more copies are selected (not shown). Additionally, an extra button, either physical like the start button 12 or a virtual feature of the user interface, may be included. The user could then scan the document and the device would generate each output with the respective output criteria designated by the user.

FIGS. 3 and 4 illustrate an exemplary embodiment of a user selectable feature for describing additional output formats. A selectable button 18 labeled “ADDITIONAL OUTPUT FORMATS” is included in each figure. A user could select the features shaded in FIG. 3 and then select the additional formats button 18 of the user interface. Selecting this button the user would be given the opportunity to enter a second set of output characteristics, such as the shaded features in FIG. 4. When finished, the user may select “ADDITIONAL OUTPUT FORMATS” button 18 again to create additional output formats. When through entering all the formats desired, the user could then start the print job.

Alternatively, the user could scan a document before designating at least one of the sets of document output criteria and other criteria could be selected after scanning without the need for rescanning the documents. For example, the scanned image could be held in the device's memory or local storage after scanning. Local storage is meant to mean in a storage or memory device that is part of the image output device 10 or directly physically connected to the device 10. The user could select different desired outputs while the scanned image was stored. The device could then produce each of these outputs. The user could select to send the document electronically to the user's email account, then print the document out on company letterhead, then print an archival copy in duplex, 2-up format. Each output would be based upon the locally stored document. If local memory or storage was used, each output could be produced upon its selection or alternatively, the user could program all three sets of criteria before beginning the output process.

In embodiments, the multifunction device could store one or more of the user's document settings. For example, if one of the output characteristic sets was for producing archival copies, the user may want that setting stored in memory for future use. It is well known in the art to save settings and allow preprogrammed settings. After the user enters settings for a particular output (such as, for example, archival copies) the device could be programmed to produce an output in accordance with those settings in addition to any being entered at the time of scan. This could happen automatically or be a selectable option. For example, the user interface could include a series of user-programmed templates that could be selected for one of the options. A virtual or a hard selectable button or switch could be used for this purpose.

FIG. 5 shows a flowchart describing the general process disclosed herein. In box 110, the user scans a document at a printing device, such as device 10. At steps 120 and 130 the user selects first and second sets of instructions regarding the output of the device. These instructions could relate to type of output such as, for example, email, fax, or hard copy output, or it could relate to format such as, for example, magnification, font type or size, and paper size. One or more of the instruction sets could be selected by entering a new set of instructions in detail or by selecting an option that would trigger a predetermined set of instructions. Also, scanning the document 110 could occur before or after steps 120 and 130. However, the document is only scanned once. After the document is scanned and the first and second instruction sets are entered, the user would begin the output jobs 140.

The embodiments disclosed herein also work for documents that are delivered to the document output device 10 through the internet or intranet from a remote device and documents that are delivered by way of a recordable medium such as, for example, floppy disk, CD-ROM, or DVD-ROM. However, given that these documents already are stored in electronic form, the embodiments disclosed herein do not provide as much advantage over current devices.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. A method for copying a document, comprising:
scanning the document exactly one time;
selecting a first set of document output characteristics for the document;
selecting a second set of document output characteristics for the document; and
after the first and second set of document characteristics are selected, automatically receiving at least one first copy having the first set of document characteristics and at least one-second copy having the second set of document characteristics.

2. The method of claim 1, wherein the first and second copies are printed copies.

3. The method of claim 1, wherein at least one of the first and second copies is an electronic copy sent to a recipient.

4. The method of claim 1, wherein one of the first and second copies is an archival copy.

5. The method of claim 1, wherein the first set and the second set of document output characteristics are selected before the document is scanned.

6. The method of claim 5, wherein the first set and the second set of document output characteristics are selected from a first set and a second set of user interface screens, respectively.

7. The method of claim 1, wherein the document is scanned into an image output device and a scanned image of the document is stored locally at the image output device while at least one of the first and second set of characteristics are entered after the document is scanned.

8. The method of claim 1, wherein at least one of the first and second sets of document output characteristics is preprogrammed and selecting the preprogrammed set of document output characteristics is accomplished by selecting a particular feature associated with that preprogrammed set.

9. The method of claim 1, further comprising:
selecting a third set of document output characteristics before receiving the first and second copies, and
after the first, second, and third set of document characteristics are selected, automatically receiving at least one third copy having the third set of document characteristics.

10. A method for copying a document, comprising:
receiving a document to be printed;
receiving a first set of document output characteristics for the document;
receiving a second set of document output characteristics for the document;
after the first and second set of document characteristics are received, automatically generating at least one first copy having the first set of document characteristics and at least one second copy having the second set of document characteristics.

11. The method of claim 10, wherein the first and second copies are printed copies.

12. The method of claim 10, wherein one of the two copies is an electronic copy sent to a recipient.

13. The method of claim 10, wherein the first and second set of document output characteristics are received before the document is received.

14. The method of claim 10, wherein one of the first and second copies is an archival copy.

15. The method of claim 10, wherein an electronic copy of the document received is stored locally at an image output device while at least one of the first and second set of characteristics are received after the document is received.

16. The method of claim 10, further comprising presenting a first set of document output choices and a second set of document output choices through a user interface.

17. The method of claim 16, wherein at least one of the first and second sets of document output characteristics is preprogrammed and associated with a selectable feature that is presented through the user interface.

18. The method of claim 10, further comprising:
receiving a third set of document output characteristics before generating the first and second copies, and
after the first, second, and third set of document characteristics are received, automatically generating at least one third copy having the third set of document characteristics.

19. An image output device, comprising:
a user interface that presents the user with a first plurality of user-selectable document output options that includes a selectable feature that when selected presents the user with a second plurality of user-selectable document output options.

20. The image output device of claim 19, first plurality of user-selectable document output options and the second plurality of user-selectable document output options are the same.
